(19) United States
(12) Patent Application Publication
(10) Pub. No.: US 2017/0307338 A1
(43) Pub. Date: Oct. 26, 2017

(54) METHOD AND DEVICE FOR PRODUCING AN ARMOR PLATING FOR PROTECTED VEHICLES

(71) Applicants: Werner Krömmer, Landshut (DE); Jörg Lorenz, Plauen (DE)

(72) Inventors: Werner Krömmer, Landshut (DE); Jörg Lorenz, Plauen (DE)

(21) Appl. No.: 15/485,783

(22) Filed: Apr. 12, 2017

(30) Foreign Application Priority Data
Apr. 22, 2016 (EP) 16000912.2

(51) Int. Cl. F41H 5/04; C23C 4/131; B05B 7/22; C23C 4/06; F41H 7/02

(52) U.S. Cl. CPC F41H 5/0442; C23C 4/06; F41H 5/045; C23C 4/131; B05B 7/224; F41H 7/02

(57) ABSTRACT

A method for producing an armor plating for protected vehicles is described. The method employs the following steps: supplying a substrate made of a metal and/or a nonmetal and coating the substrate with the aid of a thermal spraying process. A device for producing an armor plating is also described herein.

### CROSS REFERENCE TO RELATED APPLICATIONS

This application claims priority from European Patent Application EP 16000912.2 filed on Apr. 22, 2016.

### BACKGROUND OF THE INVENTION

The invention relates to a method and a device for producing an armor plating for protected vehicles. The invention particularly relates to a method and a device for producing an armor plating of materials for protected vehicles.

The armor plating of civil or military vehicles is in most cases produced of hardened steel plates consisting of special alloys of any type and shape, synthetic fibers such as aramid fibers, as well as ceramics and other materials. In this case, the resistance to different impacts is ensured by the material, its thickness, as well as its number of layers or structure. In this respect, a greater resistance is also associated with a significant weight increase.

The present invention therefore is based on the objective of making available an improved method for producing an armor plating for protected vehicles.

### SUMMARY OF THE INVENTION

Accordingly, a method for producing an armor plating for protected vehicle is proposed. The method comprises the following steps: supplying a substrate made of a metal and/or a nonmetal and coating the substrate with the aid of a thermal spraying process.

For example, the substrate may consist of a steel plate of any type and shape. The method is particularly suitable for making available an armor plating of materials for protected vehicles. In the present context, the term nonmetals refers to synthetic materials such as Kevlar, ceramics, composite materials and composite fiber materials. The term thermal spraying process refers to a surface coating process. In this case, additional materials in the form of so-called spray additives are fused or molten inside and outside a burner, accelerated in the form of a particle spray in a flow of gas and thrown on the surface of the substrate to be coated. In this case, the surface of the substrate is not molten and only subjected to low thermal stress. A layer formation takes place because the spray particles more or less flatten depending on the process and the material when they impact on the surface of the substrate such that they remain adherent, primarily by interlocking mechanically, and thereby build up the spray coating layer-by-layer. Quality characteristics of such spray coatings are a low porosity, a sound connection to the substrate, the absence of cracks and a homogenous microstructure. The attained layer properties are decisively influenced by the temperature and the speed of the spray particles at the time of their impact on the surface to be coated. For example, an electric arc, a plasma jet, an oxy-fuel flame or high-velocity oxy-fuel flame, fast preheated gases or a laser beam may be used as energy carriers for fusing or melting the spray additive. Examples of thermal spraying processes are melt spraying, arc spraying, plasma spraying, flame spraying, high-velocity flame spraying, detonation spraying, cold gas spraying or laser spraying.

The thickness and therefore also the weight of the substrate can be reduced by coating the substrate. Conventional coatings, which are not applied by means of a thermal spraying process, chip off over large areas due to their brittleness. The required armor plating therefore is no longer ensured with conventional methods. The coating applied on the substrate has an extremely high hardness, as well as a certain ductility and adhesion. In case particles nevertheless chip off during the bombardment, no larger areas are exposed such that the protection standard can be met. A significant improvement of the armor plating can already be achieved with small layer thicknesses between 50 and 400 μm.

According to an embodiment, the substrate is coated with the aid of an arc spraying process.

The arc spraying process, which is also referred to as arc wire spraying or wire arc spraying, is a highly effective wire spraying process for producing coatings, in which electrically conductive materials are sprayed. In this case, an arc is ignited between two wire-shaped spray materials of identical or different types. The wire tips are molten at a temperature of around 4000 to 5000° C. and blown on the prepared surface of the substrate by means of an atomizing gas or process gas. Oxidation of the materials is reduced if an atomizing gas in the form of nitrogen or argon is used instead of air. Practically any electrically conductive wire-shaped material can be used as material for the spray wires. Hard material layers can also be produced by using hollow wires with carbidic or ceramic fillings. The arc spraying process is characterized by very high application rates.

According to another embodiment, the arc spraying process is carried out with a process gas in the form of nitrogen, a nitrogen-active gas mixture or air.

Oxidation of the coating material and/or the substrate material can be prevented by using nitrogen. The use of an active gas makes it possible to achieve a chemical reaction.

According to another embodiment, a coating with a layer thickness of 50 to 400 μm is applied on the substrate.

However, the layer thickness may also be greater than 400 μm,

According to another embodiment, the coating is produced of a hard material alloy.

The coating is preferably produced of a metallic material. However, the coating may also be produced of a ceramic material.

According to another embodiment, the substrate is a steel plate.

However, the substrate may also be made of a different metallic or non-metallic material.

A device for producing an armor plating for protected vehicles is furthermore proposed. The device comprises a supply apparatus for supplying a substrate consisting of a metal and/or a nonmetal and a coating apparatus for coating the substrate with the aid of a thermal spraying process.

The device particularly is an arc spraying device,

According to an embodiment, the device comprises a first wire feed for a first spray wire and a second wire feed for a second spray wire.

Each wire feed preferably features two rollers, between which the respective spray wire is arranged. The respective spray wire can be advanced by rotating the rollers. The device may also feature more than two wire feeds and therefore process more than two spray wires,

According to another embodiment, the device furthermore comprises a first wire guide for the first spray wire and a second wire guide for the second spray wire.

The first wire feed particularly delivers the first spray wire to the first wire guide and the second wire feed delivers the second spray wire to the second wire guide. The wire guides are realized in the form of contact tips and therefore electrically conductive. The wire guides may be made, for example, of a copper alloy. The wire guides preferably form part of an electric circuit of the device. In addition to the wire guides, the electric circuit also comprises a power source, particularly a dc power source. For example, the first wire guide is wired as the positive pole and the second wire guide is wired as the negative pole of the electric circuit.

According to another embodiment, the device furthermore comprises an atomizer nozzle that is arranged between the first wire guide and the second wire guide.

The device particularly comprises an atomizer nozzle that is cylindrically arranged around both wire guides. The spray wires guided through the wire guides preferably meet in front of the atomizer nozzle such that an arc forms in front of the atomizer nozzle. Process gas conveyed through the atomizer nozzle atomizes the material of the spray wires molten in the arc and throws it on the substrate to be coated.

Other potential implementations of the method and/or device also include combinations of characteristics and embodiments described above and below, which are not explicitly mentioned. In this respect, a person skilled in the art may also add individual aspects to the respective basic principle of the method and/or device as enhancements or supplements.

### BRIEF DESCRIPTION OF THE DRAWINGS

Other advantageous embodiments and aspects of the method and/or device form the objects of the dependent claims, as well as the exemplary embodiments of the method and/or the device described below. Preferred embodiments of the method and/or device accordingly are described in greater detail below with reference to the attached figures.

FIG. 1 shows a schematic side view of an embodiment of a protected vehicle;

FIG. 2 shows a schematic view of an embodiment of a device for producing an armor plating for the protected vehicle according to FIG. 1;

FIG. 3 shows a schematic sectional view of an embodiment of an armor plating produced with the aid of the device according to FIG. 2;

FIG. 4 shows a schematic block diagram of an embodiment of a method for producing an armor plating for the protected vehicle according to FIG. 1;

FIG. 5 shows a schematic sectional view of another embodiment of an armor plating produced with the aid of the device according to FIG. 2; and

FIG. 6 shows a schematic sectional view of another embodiment of an armor plating produced with the aid of the device according to FIG. 2.

If not indicated otherwise, identical or functionally identical elements are identified by the same reference symbols in the figures.

### DETAILED DESCRIPTION OF THE INVENTION

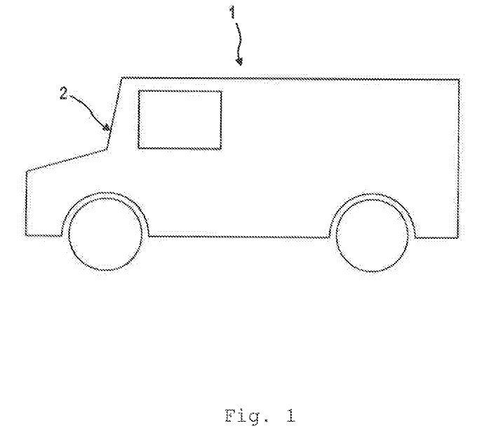

FIG. 1 shows a schematic side view of an embodiment of an armored or protected vehicle 1. Protected vehicles 1 of this type serve for transporting persons and materials. These protected vehicles 1 have standard chassis, are based on commercial sedans, all-terrain vehicles or light trucks and provide protection against booby-traps, IED's (improvised explosive devices) and mines, as well as small arms fire during an armed assault or ambush, for example, in accordance with VPAM test guidelines (Association of Test Centers for Attack-blocking Materials and Constructions) or in accordance with STANAG 4569 (NATO AEP-55 STANAG 4569 is a NATO standardization agreement covering the standards for the “Protection Levels for Occupants of Logistic and Light Armored Vehicles”).

The vehicle 1 illustrated in FIG. 1 is a motor vehicle. However, the protected vehicle 1 may also be a watercraft, an aircraft or a rail vehicle. The protected vehicle 1 particularly may be a military vehicle. The protected vehicle 1 comprises a protected occupant compartment 2. The protected vehicle 1 may be a wheeled vehicle. The protected vehicle 1, particularly the protected occupant compartment 2, is protected with the aid of an armor plating or armoring plate. The armor plating may be made of coated metallic or non-metallic plates of any type and shape. The armor plating particularly may be made of steel plates.

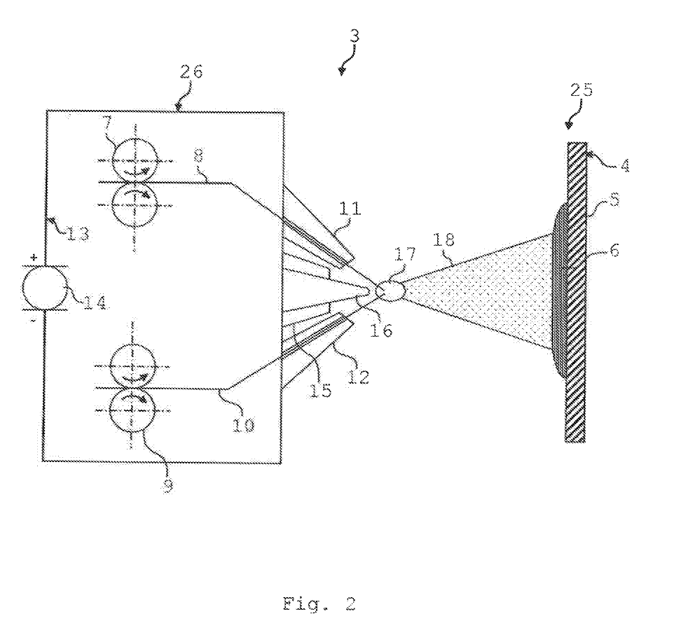

FIG. 2 shows a schematic view of a device 3 for producing an armor plating 4 for the protected vehicle 1. The armor plating 4 may also be referred to as armoring plate. The armor plating 4 comprises a substrate 5 that is made of a metal or a nonmetal and has the shape of a plate. A spray coating 6 is provided on the substrate 5. The coating 6 is applied on the substrate 5 with the aid of the device 3 in a thermal spraying process.

In a thermal spraying process according to DIN EN 657, additional materials in the form of so-called spray additives are fused or molten inside and outside a burner, accelerated in the form of a particle spray in a flow of gas and thrown on the surface of the substrate 5 to be coated. In this case, the surface of the substrate 5 is not molten and only subjected to low thermal stress. A layer formation takes place because the spray particles more or less flatten depending on the process and the material when they impact on the surface of the substrate 5 such that they remain adherent, primarily by interlocking mechanically, and thereby build up the coating 6 layer-by-layer,

The device 3 is particularly suitable for applying the coating 6 on the substrate 5 in an arc spraying process. The device 3 therefore is an arc spraying device and, in particular, a wire flame spraying device. The device 3 comprises a first wire feed 7 for advancing a first spray wire 8 and a second wire feed 9 for advancing a second spray wire 10. The first spray wire 8 is guided through a first wire guided 11 and the second spray wire 10 is guided through a second wire guide 12. The wire guides 11, 12 are made of a metallic material. For example, the wire guides 11, 12 may be made of a copper alloy.

The wire guides 11, 12 form part of an electric circuit 13 with a power source 14. The power source 14 may be a dc power source. For example, the first wire guide 11 may be wired as the positive pole and the second wire guides 12 may be wired as the negative pole or vice versa. An atomizer nozzle 15 is provided between the wire guides 11, 12. A pressurized atomizing gas or process gas 16 is conveyed through the atomizer nozzle 15. The process gas may consist, for example, of nitrogen, a nitrogen-active gas mixture or air.

During the operation of the device, the two electrically conductive spray wires 8, 10 with identical or different composition are moved in front of the atomizer nozzle 15 with a controlled wire feed. The power transmission is realized by means of the wire guides 11, 12 in this case. After the wire feeds 7, 9 have been activated, the two spray wires 8, 10 are advanced through the wire guides 11, 12 until they contact one another. Significant heating occurs as a result of the short circuit current such that the metal of the spray wires 8, 10 evaporates and an arc 17 is ignited, which then optimally remains short circuit-free.

The attainable temperatures in the arc 17 lie at about 4000 to 5000° C. The material of the spray wires 8, 10 is molten and the process gas 16 discharged from the atomizer nozzle 15 atomizes the molten material, accelerates the particles up to 150 m/s and throws them on the substrate 5 to be coated. The particle atomization and particle acceleration can be influenced by choosing the atomizer nozzle 15 accordingly. The arc spraying process can likewise be carried out with more than two spray wires 8, 10, e.g. with three or four spray wires, in the form of a multi-wire arc spraying process. For example, the application rate of the device 3 lies between 8 and 20 kg/h. The atomized material of the spray wires 8, 10 is deposited on the substrate 5 with the aid of a spray cone 18 formed by the process gas 16 and the atomized material of the spray wires 8, 10.

In an arc spraying process, the arc 17 is subject to many interferences and, in contrast to welding technology, represents a discontinuously burning dc arc. The interferences leading to irregular burning and therefore constant restabilizing are caused by the process gas 16 and irregular processes between the two spray wires 8, 10, as well as by melting the wire ends of the spray wires 8, 10 and the spray particles created thereby. If they separate, the cross-sectional areas and the respective diameters of the spray wires 8, 10, as well as the length of the arc 17 on the wire ends of the spray wires 8, 10, is reduced.

With respect to a stable spraying process, it is advantageous to realize the shortest arc 17 possible because such an arc heats the wire ends of the spray wires 8, 10 more evenly, is subjected to less interference by separating spray particles and the gas flow and therefore encounters more consistent conditions. This results in very high melting rates. Depending on the material of the spray wires 8, 10 used, the voltages lie in the range between 18 and 40 V. In this respect, the spray wires 8, 10 should always be processed with the lowest voltage possible. The optimal arc voltage corresponds to the lowest voltage, at which the spray wires 8, 10 still burn off short circuit-free and therefore without sputters. The feed rate of the spray wires 8, 10 makes it possible to adjust the current between 50 and 350 A in dependence on the required application rate, the material, the wire diameter and the available arc system.

All electrically conductive spray additives that can be produced in the form of a spray wire 8, 10 are suitable for the arc spraying process. In most cases, spray wires with a diameter of 1.6 mm are used. If they are made of low-melting materials such as zinc, the spray wires 8, 10 used may have a diameter of 2.0 mm. The highest application rates of all spraying processes can be achieved with the arc spraying process. When aluminum is processed, an application rate of up to 15 kg/h can be achieved, wherein an application rate of up to 45 kg/h can be achieved when processing zinc and an application rate of up to 30 kg/h can be achieved when processing steel. If a particularly strong adhesion should be achieved, e.g. on undercoatings, the spraying distance can be reduced to 80 mm. Coatings 6 of materials or material combinations, which cannot be produced in the form of a wire, can be applied by means of filled hollow wires.

The device 3 particularly comprises a supply apparatus 25 for supplying the substrate 5. The supply apparatus 25 may consist, for example, of a conveyor belt or a transfer gripper. The device 3 furthermore comprises a coating apparatus 26. The coating apparatus 26 may comprise the electric circuit 13, the wire feeds 7, 9, the wire guides 11, 12 and the atomizer nozzle 15.

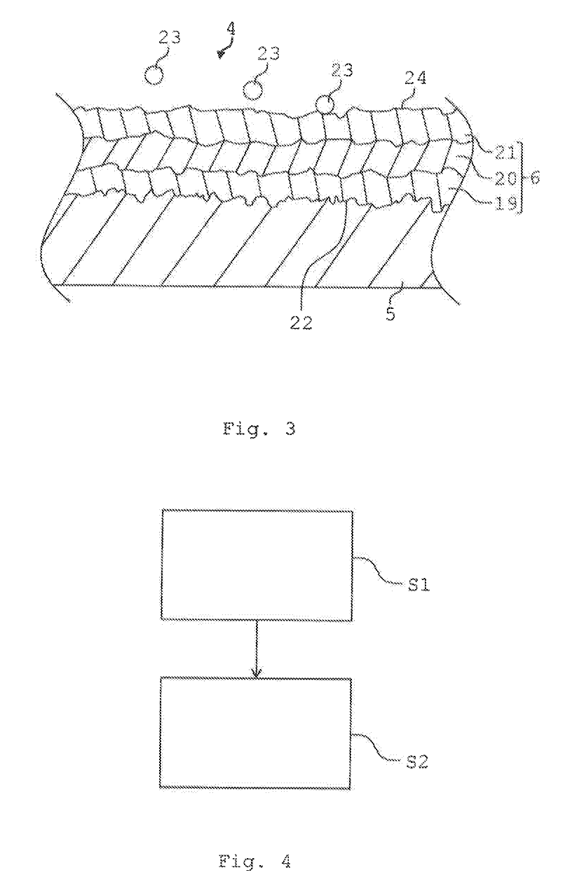

FIG. 3 shows an example of a coating 6 that is applied on a substrate 5 made of a steel alloy. The coating 6 is applied on the substrate 5 in several layers 19-21. The substrate 5 has a microstructured surface 22 that is positively and/or integrally connected to the bottom layer 19. A positive connection is produced by at least two connection partners interlocking into or behind one another. In integral connections, the connection partners are held together by atomic or molecular forces. Integral connections are inseparable connections that can only be separated by destroying the connecting means. The layers 19-21 are once again positively and/or integrally connected to one another. Molten spray particles 23 from the spray cone impact on a surface 24 of the coating 6 with high velocity and connect thereto. The coating 6 preferably has a layer thickness d₆ of 50 to 400 μm.

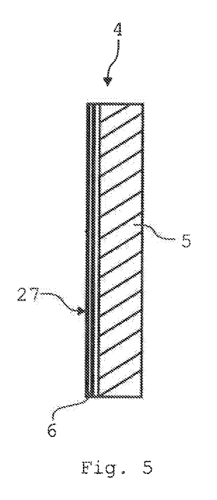

FIG. 4 shows a schematic block diagram of an embodiment of a method for producing the armor plating 4. The method comprises a step S1 of supplying the substrate 5 made of a metal or a nonmetal, The method furthermore comprises a step S2 of coating the substrate 5 with the aid of a thermal spraying process. The thermal spraying process used as an arc spraying process. The process particularly is an arc wire spraying or wire arc spraying process.

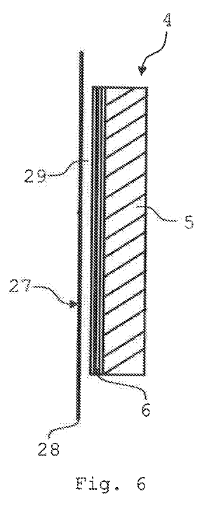

FIGS. 5 and 6 show schematic sectional views of two different embodiments of armor platings 4. In the embodiment of the armor plating 4 according to FIG. 5, the coating 6 forms the side 27 of the armor plating 4 coming under fire. The armor plating 4 according to FIG. 6 can be distinguished from the armor plating 4 according to FIG. 5 in that an additional vehicle body sheet 28 is provided. The vehicle body sheet 28 comprises the side 27 coming under fire. An air gap 29 is provided between the vehicle body sheet 28 and the coating 6.

Although the present invention was described entirely with reference to exemplary embodiments, it can be modified in various ways.

### USED REFERENCE NUMBERS

1 Vehicle
2 Occupant compartment
3 Device
4 Armor plating
5 Substrate
6 Coating
7 Wire feed
8 Spray wire
9 Wire feed
10 Spray wire
11 Wire guide
12 Wire guide
13 Electric circuit
14 Power source
15 Atomizer nozzle
16 Process gas
17 Arc
18 Spray cone
19 Layer
20 Layer
21 Layer
22 Surface
23 Spray particle
24 Surface
25 Supply apparatus
26 Coating apparatus
27 Side coming under fire
28 Vehicle body sheet
29 Air gap
d₆ Layer thickness
S1 Step
S2 Step

What we claim is:

1. A method for producing an armor plating for protected vehicles, comprising the following steps:
supplying a substrate made of a metal and/or a nonmetal; and
coating the substrate with the aid of a thermal spraying process.

2. The method according to claim 1, wherein the substrate is coated with the aid of an arc spraying process.

3. The method according to claim 2, wherein the arc spraying process is carried out with the aid of a process gas in the form of nitrogen, a nitrogen-active gas mixture or air.

4. The method according to claim 1, wherein a coating with a layer thickness of 50 to 400 μm is applied on the substrate.

5. The method according to claim 4, wherein the coating is produced of a hard material alloy.

6. The method according to claim 1, wherein the substrate is a steel plate.

7. A device for producing an armor plating for protected vehicles with a supply apparatus for supplying a substrate made of a metal and/or a nonmetal and a coating apparatus for coating the substrate with the aid of a thermal spraying process.

8. The device according to claim 7, comprising a first wire feed for a first spray wire and a second wire feed for a second spray wire.

9. The device according to claim 8, further comprising a first wire guide for the first spray wire and a second wire guide for the second spray wire.

10. The device according to claim 9, further comprising an atomizer nozzle that is arranged between the first wire guide and the second wire guide.
